(19) United States
(12) Patent Application Publication
(10) Pub. No.: US 2011/0193807 A1
(43) Pub. Date: Aug. 11, 2011

(54) Touch Detection Method and Touch Detection Device and Touch Display Device

(76) Inventors: Hao-Jan Huang, Hsinchu City (TW); Ching-Chun Lin, Taipei County (TW)

(21) Appl. No.: 13/017,031

(22) Filed: Jan. 30, 2011

(30) Foreign Application Priority Data
Feb. 9, 2010 (TW) 099103921

(51) Int. Cl. G06F 3/041

(52) U.S. Cl. 345/173; 178/18.03

(57) ABSTRACT

A touch detection method is utilized for detecting touch events in a flat panel display. The flat panel display includes a plurality of source lines and a plurality of gate lines perpendicular to the plurality of source lines. The touch detection method includes sequentially detecting waveforms of the plurality of source lines when receiving a plurality of source driving signals, and when a gate line of the plurality of gate lines receives a gate driving signal, to generate a plurality of detection results, and determining a status of a touch event according to the plurality of detection results and position of the gate line relative to the plurality of gate lines.

### BACKGROUND OF THE INVENTION

1. Field of the Invention

The present invention relates to a touch detection method, touch detection device, and touch display device, and more particularly, to a touch detection method, touch detection device, and touch display device capable of simplifying panel circuits and enhancing display quality.

2. Description of the Prior Art

A touch display device has merits of convenient operation, rapid response, and saving space, such that the touch display device has become an important input interface, and been widely used in various consumer electronic products, such as personal digital assistants, personal computers, smart mobile phones, notebooks, and point of sale systems (POS). Specifically, the touch display device is composed of a (LCD or CCFL) display device and a transparent touch pad, and in detail, is made by fixing the transparent touch pad onto the display device, to fulfill both touch and display functions.

The touch display device can be categorized by sensing technique into resistive, capacitive, optical touch display devices, and etc., and the operational principles thereof are well known for those skilled in the art. However, resistive, capacitive, and optical touch display devices are all simple combinations of a display and a transparent touch panel. For example, please refer to FIG. 1A and FIG. 1B. FIG. 1A is a schematic diagram of a prior art touch display device 10, while FIG. 1B is a cross-sectional diagram of the touch display device 10 along point A to point A′. The touch display device 10 is composed of a liquid crystal display (LCD) panel 100 and a transparent touch pad 102. The liquid crystal display (LCD) panel 100 and the transparent touch pad 102 are agglutinated together by glue or other material. In other word, the prior art touch display device 10 is a device combining the liquid crystal display (LCD) panel 100 and the transparent touch pad 102, to fulfill both touch and display functions. Such combination does not help integration of the hardware structures of the liquid crystal display (LCD) panel 100 and the transparent touch pad 102, and may further cause an increment to the whole thickness; thus, it is necessary to improve the prior art touch display device 10.

### SUMMARY OF THE INVENTION

It is therefore a primary objective of the claimed invention to provide a touch detection method, touch detection device, and touch display device.

The present invention discloses a touch detection method, for detecting touch events in a flat panel display. The flat panel display includes a plurality of source lines and a plurality of gate lines perpendicular to the plurality of source lines. The touch detection method includes sequentially detecting waveforms of the plurality of source lines when receiving a plurality of source driving signals, and when a gate line of the plurality of gate lines receives a gate driving signal, to generate a plurality of detection results, and determining a status of a touch event according to the plurality of detection results and position of the gate line relative to the plurality of gate lines.

The present invention further discloses a touch detection device, for detecting touch events in a flat panel display. The flat panel display includes a plurality of source lines and a plurality of gate lines perpendicular to the plurality of source lines. The touch detection device includes a touch detection unit, for sequentially detecting waveforms of the plurality of source lines when receiving a plurality of source driving signals, and for when a gate line of the plurality of gate lines receives a gate driving signal, to generate a plurality of detection results, and a determination module, for determining a status of a touch event according to the plurality of detection results and position of the gate line relative to the plurality of gate lines.

The present invention further discloses a flat display device having display and touch functions, which includes a display panel, an image driving module, and a touch detection device. The display panel includes a plurality of pixel units, a plurality of source lines, and a plurality of gate lines perpendicular to the plurality of source lines, each pixel unit formed at an intersection of a source line and a gate line. The image driving module is utilized for outputting a plurality of control signals and a plurality of image data to the plurality of gate lines according to an image data, to drive the plurality of pixel units to display images. The touch detection device includes a touch detection unit, for sequentially detecting waveforms of the plurality of source lines when receiving a plurality of source driving signals, and when a gate line of the plurality of gate lines receives a gate driving signal, to generate a plurality of detection results, and a determination module, for determining a status of a touch event according to the plurality of detection results and position of the gate line relative to the plurality of gate lines.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1A is a schematic diagram of a touch display device according to the prior art.

FIG. 1B is a cross-sectional diagram of the touch display device in FIG. 1A.

FIG. 2A is a schematic diagram of a touch display device according to an embodiment of the present invention.

FIG. 2B is a cross-sectional diagram of the touch display device in FIG. 2A.

FIG. 2C is a functional block diagram of the touch display device in FIG. 2A.

FIG. 3A and FIG. 3B are schematic diagrams of the image driving module in FIG. 2A.

FIG. 4 is a schematic diagram of the relevant signals of the detection unit in FIG. 2A.

FIG. 5 is a schematic diagram of the detection unit in FIG. 2A.

FIG. 6 is a schematic diagram of the comparison results of the comparison unit in FIG. 2A.

FIG. 7 is a schematic diagram of a touch detection process according to an embodiment of the present invention.

### DETAILED DESCRIPTION

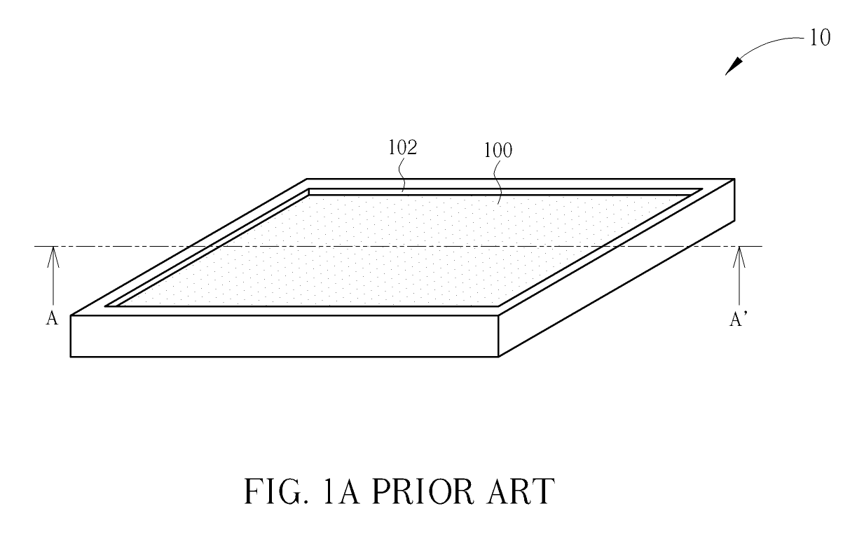

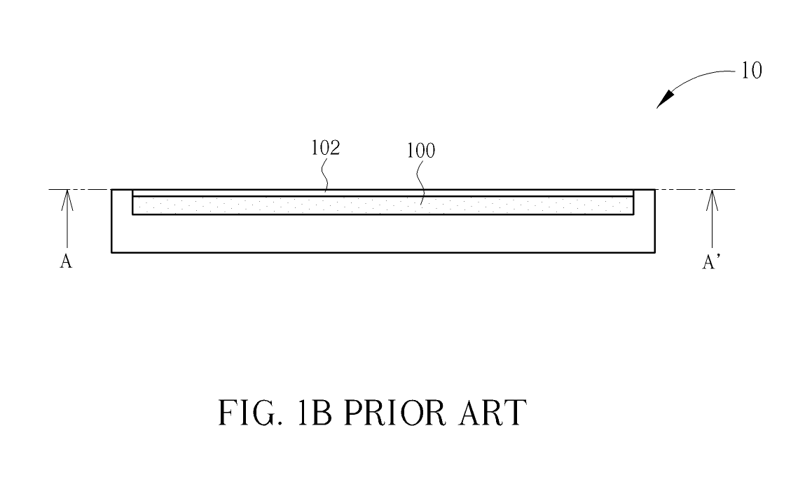

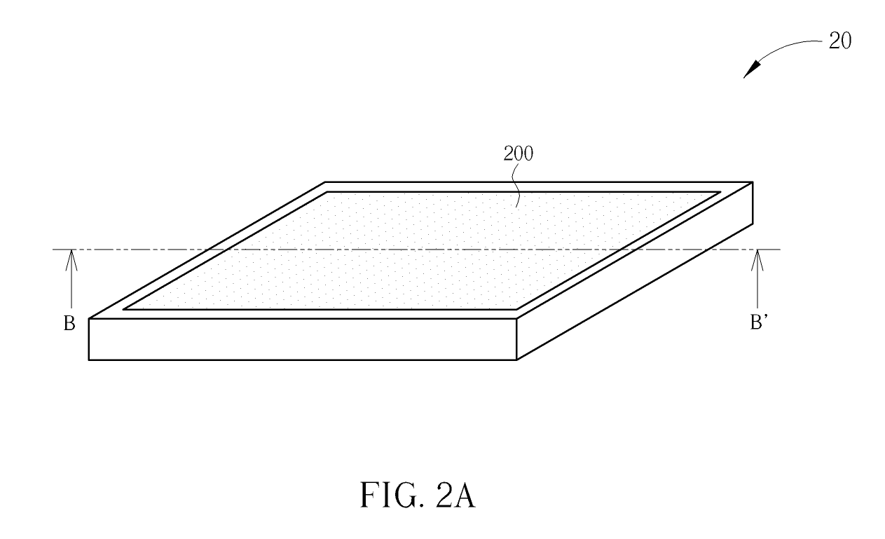

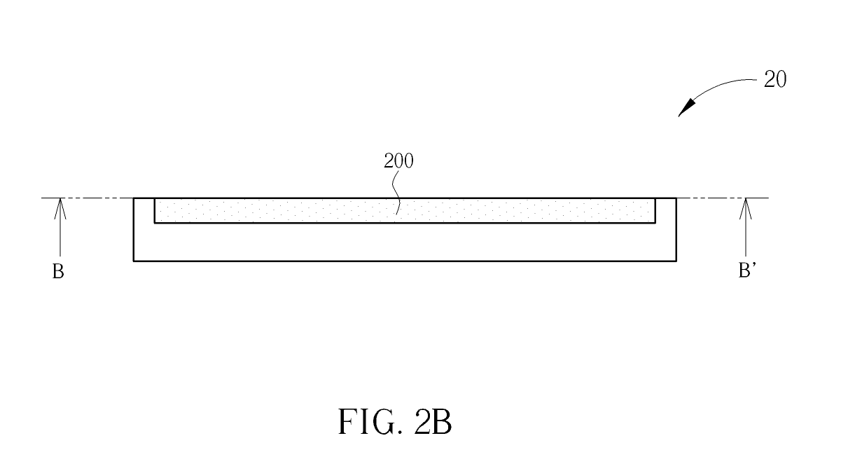

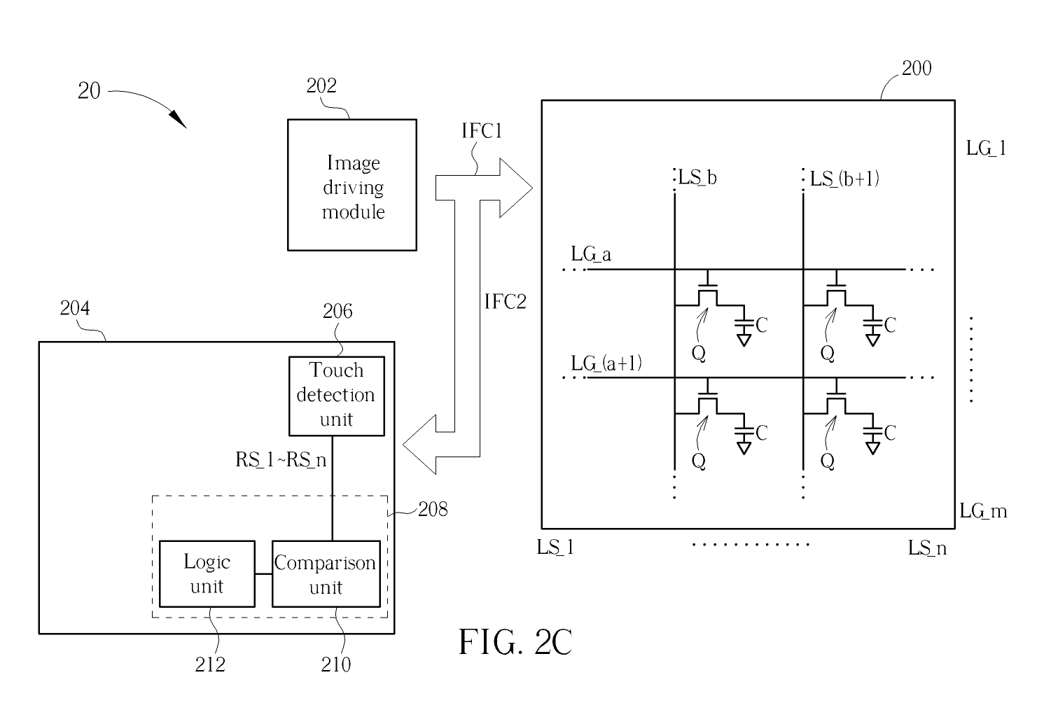

Please refer to FIG. 2A to FIG. 2C. FIG. 2A is a schematic diagram of a touch display device 20 according to an embodiment of the present invention, FIG. 2B is a cross-sectional diagram of the touch display device 20 along a line from point B to point B′, and FIG. 2C is a functional block diagram of the touch display device 20. As can be seen from FIG. 2A and FIG. 2B, the touch display device 20 fulfills both touch and display functions via only a liquid crystal display panel 200. In other words, no extra transparent touch pad 102 in FIG. 1 needed to be installed in the touch display device 20 to reach the goal of detecting touch events.

In detail, as illustrated in FIG. 2C, the liquid crystal display panel 200 is formed by liquid crystal stuffed between two substrates. On one of the two substrates is disposed source lines LS_1-LS_n, gate lines LG_1-LG_m, and a plurality of thin-film transistors (TFTs) Q. On the other substrate is disposed a common electrode. The structure of the liquid crystal display panel 200 is well known for those skilled in the art, and is not a dominant issue of the present invention. Thus, FIG. 2C denotes the liquid crystal display panel 200 with only the source lines LS_b and LS_(b+1), the gate lines LY_a and LY_(a+1), and four TFTs Q for simplicity. Moreover, the characteristic of the two substrates of the liquid crystal display panel 200 can be represented by an equivalent capacitor C. Besides the liquid crystal display panel 200, the touch display device 20 further comprises an image driving module 202 and a touch detection device 204. According to image data to be shown, the image driving module 202 outputs source driving signals DS_1-DS_n to the source line LS_1-LS_n and gate driving signals DG_1-DG_m to the gate lines LG_1-LG_m to control conductivities of each TFT Q and voltage differences of the equivalent capacitor C, and further changes the arrangement of liquid crystal molecules and corresponding light transmittance, to control gray levels of corresponding pixels; hence, image is displayed on the panel.

Note that, the image driving module 202 represents a combination of elements, circuits, firmware, etc. utilized for controlling the liquid crystal display panel 200 to display images in the touch display device 20. In practice, the image driving module 202 may comprise a timing controller, gate driver, source driver, and common voltage generator, while for clarity, these are simplified to a functional block of the image driving module 202 on the premise that the concept of the present invention is not affected. Likewise, an interface IFC1 between the image driving module 202 and the liquid crystal display panel 200 denotes all tangible or intangible connections, may vary according to application scope or system requirement, and is not limited to the above.

In order to fulfill touch and display functions without an extra transparent touch pad, the touch display device 20 utilizes the source lines LS_1-LS_n originally formed in the liquid crystal display panel 200 to sense electric variations caused by a finger or object. Accordingly, with the activation sequence of each gate lines in the liquid crystal display panel 200, the touch display device 20 determines whether a touch event occurs, or where and when a touch event occurs via the touch detection device 204. In detail, as illustrated in FIG. 2C, the touch detection device 204 comprises a touch detection unit 206 and a determination module 208. The touch detection unit 206 is utilized for sequentially detecting waveforms of the source lines LS_1-LS_n outputted from the image driving module 202 when a gate line LG_y among the gate lines LG_1-LG_m receives a gate driving signal DG_y, to generate detection results RS_1-RS_n, and outputs the detection results RS_1-RS_n to the determination module 208. The determination module 208 includes a comparison unit 210 and a logic unit 212. The comparison unit 210 sequentially compares the detection results RS_1-RS_n (i.e. waveforms of the source lines LS_1-LS_n when the source driving signals DS_1-DS_n are received) with waveforms of the source lines LS_1-LS_n when the image driving module 202 generates the source driving signals DS_1-DS_n. The logic unit 212 determines status of the touch event including whether a touch event occurs, and/or where and when a touch event occurs according to comparison results generated by the comparison unit 210. In other words, when the image driving module 202 activates the gate line LG_y, the touch detection device 204 sequentially detects whether the waveforms of the source driving signals LS_1-LS_n outputted by the source lines LS_1-LS_n are influenced by a touch event via the interface IFC2. If waveform of a source driving signals DS_x outputted by the source line LS_x is influenced by a touch event, it represents that a touch event occurs at the intersection of the gate line LG_y and the source line LS_x or in the vicinity. Similarly, take progressive scan as an example, each time when the image driving module 202 drives the liquid crystal display panel 200 to display an image completely, the touch detection device 204 completes a full detection (i.e. completes detection of each point). As to an interlaced scan case, each time when the image driving module 202 drives the liquid crystal display panel 200 to display two images completely, the touch detection device 204 completes a full detection.

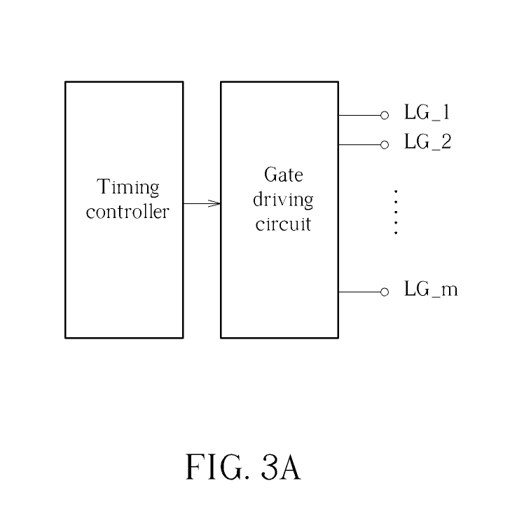

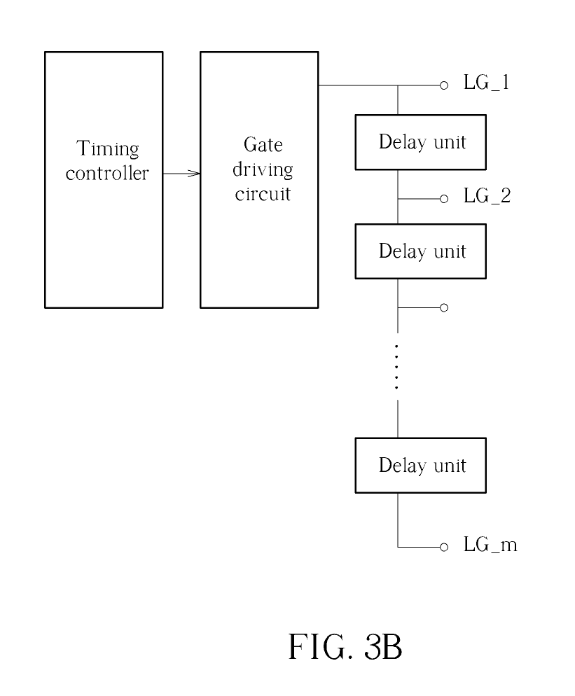

Note that, the above operations (when the image driving module 202 activates the gate line LG_y, the touch detection device 204 starts to detect the waveform of the source driving signals DS_1-DS_n) are utilized for denoting concepts of the present invention, and the corresponding realization can be adequately modified according to different requirements. For example, the design of gate driving circuit of the image driving module 202 can be generally categorized two ways. One is the gate driving circuit is coupled to each gate lines (LG_1-LG_m), and output timing of each gate driving signal is controlled by a timing controller, as shown in FIG. 3A. The other is the gate driving circuit is merely coupled to the first gate line (LG_1), and a delay unit is coupled to adjacent gate lines, for adequately delaying the gate driving signal and transmitting the delayed gate driving signal to the next gate line. However, no matter what kind of gate driving method is adopted (FIG. 3A, FIG. 3B or others), for accurately displaying the image, the timing controller has sufficient information about the time when the gate lines LG_1-LG_m receives the gate driving signals DG_1-DG_m. Accordingly, the determination module 208 determines the status of the touch event. That is to say, while implementing the touch detection device 204, the touch detection unit 206 continuously detects the waveforms of the source driving signals outputted to the source line LS_1-LS_n according to a certain timing relevant to the activation of the gate lines LG_1-LG_m (i.e. receiving the gate driving signal). When a detection result of the touch detection unit 206 indicates that a touch occurs on a certain source line, the determination module 208 determines the corresponding gate line according to the time of the detection result, so as to assure the location where the touch occurs.

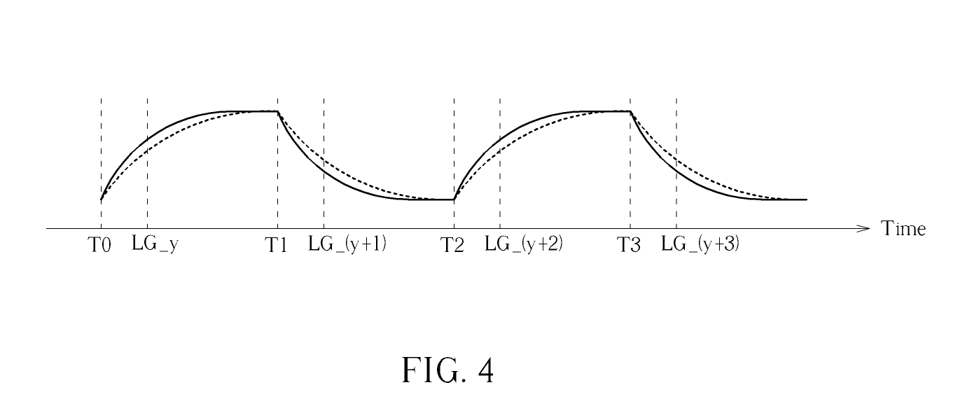

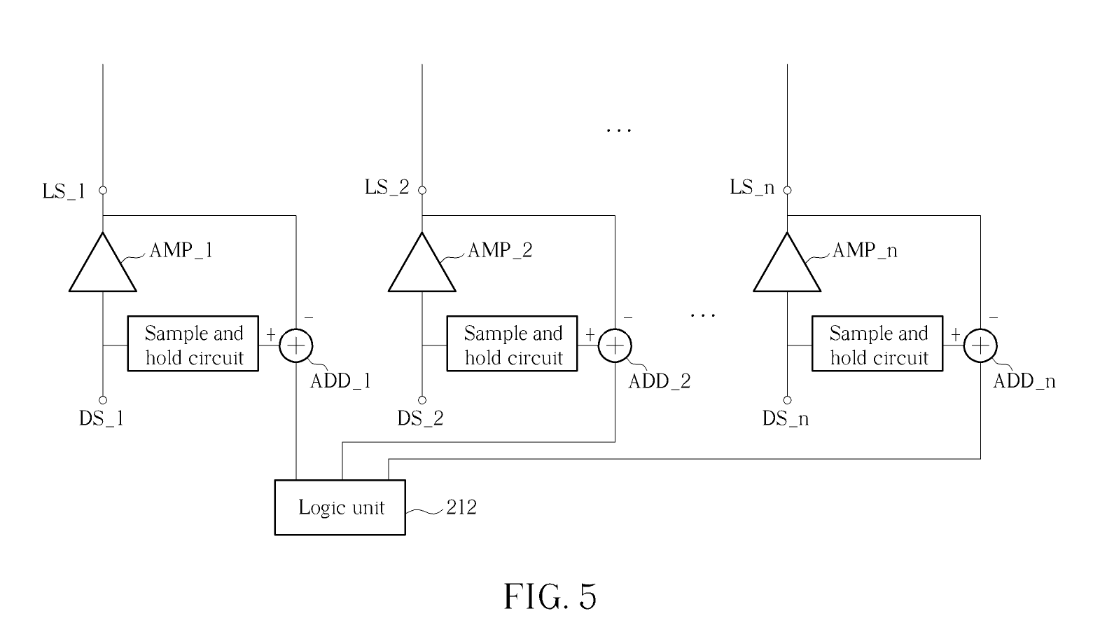

Therefore, as to each source line among the source lines LS_1-LS_n, when the image driving module 202 adopts line reverse driving or reverse driving, the detection result of the touch detection unit 206 can be illustrated in FIG. 4. In FIG. 4, the continuous line represents the waveform of the source driving signal when no touch occurs, while the dot line represents the waveform of the source driving signal when a touch occurs. Furthermore, for clarity, FIG. 4 denotes the detection result of the touch detection unit 206 with the waveform of the same gray level. Therefore, it can be seen from FIG. 4 that when a touch occurs, the waveform of the source driving signal is influenced and becomes different. In addition, since the amplitude of the source driving signal varies under different gray levels, for accurately comparing whether a touch event occurs, the comparison unit 210 compares the waveforms detected by the touch detection unit 206 with the waveforms of the signals outputted by the gate driving circuit. To realize the implementation, as shown in FIG. 5, sample and hold circuits SH_1-SH_n are adopted to implement the touch detection unit 206, and adders ADD_1-ADD_n are adopted to implement the comparison unit 210.

In FIG. 5, the source driving signals DS_1-DS_n outputted from the image driving module 202 are amplified by the amplifiers AMP_1-AMP_n, and are outputted to the source lines LS_1-LS_n. Hence, via the sample and hold circuits SH_1-SH_n, the source driving signals DS_1-DS_n that do not undergo processing of the amplifiers AMP_1-AMP_n are sampled to be sampling results and stored. Next, via adders ADD_1-ADD_n, the sampling results of the sample and hold circuits SH_1-SH_n subtract the source driving signals DS_1-DS_n outputted to the source lines LS_1-LS_n. Under such circumstances, the logic unit 212 determines whether a difference value of a source driving signal is larger than a predetermined value according to subtraction results of the adders ADD_1-ADD_n, so as to determine whether a touch event occurs.

As can be seen from the above, besides the merit of fulfilling touch and display functions without an extra transparent touch pad, the touch detection device 204 is capable of acquiring the position where the touch occurs on a two-dimensional coordinate system by merely detecting the waveforms of the source driving signals DS_1˜DS_n and the time when the gate lines LG_1-LG_m receives the gate driving signals DG_1-DG_m. Note that, modifications or variations thereof are within the scope of the present invention. For example, the objective of utilizing the touch detection unit 206 is timely detecting the waveform of each gate driving signal is fulfilled. Hence, detection of each gate driving signal can be performed within a specific time Δt, i.e. (T0+Δt), (T1+Δt), (T2+Δt), etc. in FIG. 4. Furthermore, basis of the touch detection unit 206 activating the detection only has to be relevant to the time when the gate lines LG_1-LG_m are receiving the gate driving signals DG_1-DG_m. For example, if the gate lines LG_1 and LG_m are disposed on a non-displayed area of the liquid crystal display panel 200, the touch detection unit 206 can be designed to be activated at a specific time after the gate line LG_1 receives the gate driving signal DG_1, and deactivated when the gate line LG_m receives the gate driving signal DG_m. In addition, an erroneous decision detection mechanism can be added. For example, when a predetermined amount of comparison results are larger than a predetermined value at the same time, the logic unit 212 may determine an erroneous decision occurs.

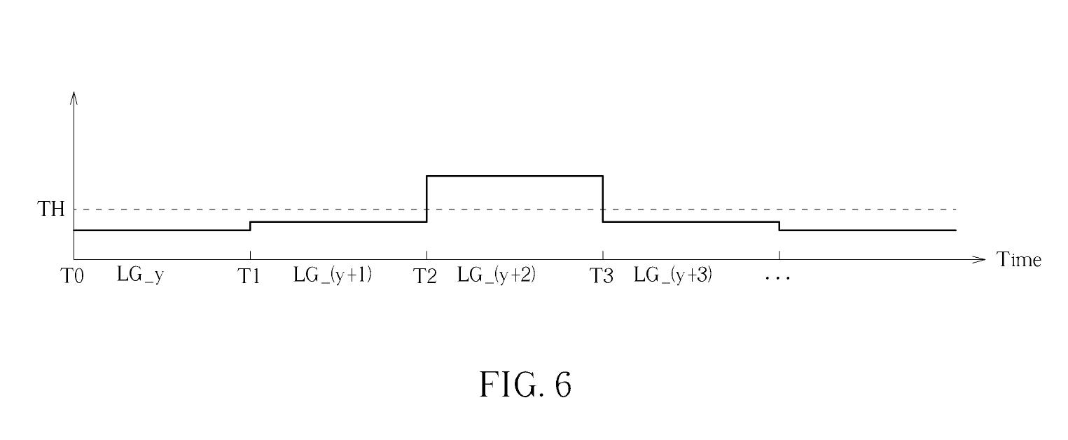

On the other hand, when a finger stays at a certain source line among the source lines LS_1-LS_n, it results in a change in electric characteristics of the source line. However, range of this change is much smaller than the changing range of the electric characteristics of the equivalent capacitor C. Therefore, observing the difference value of the waveform (i.e. the comparison result of the comparison unit 210), only when the gate line corresponding to a touch point is activated, the difference value of the waveform increases remarkably. For example, FIG. 6 illustrates the difference value of the waveform (i.e. the comparison result of the comparison unit 210) corresponding to each source line LS_x in digital format. As can be seen from FIG. 6, between time T2 and time T3, the difference value of the waveform exceeds a threshold value TH; thus, a touch event can be determined as occurred on the intersection of the gate line LG_(y+2) and source line LS_x. Furthermore, it can be observed from FIG. 6 that in the vicinity of the touch point (i.e. near the time T2 and time T3), the difference value of the waveform changes slowly. Accordingly, it can be determined whether an erroneous decision occurs. For example, if a difference value of a waveform exceeds the threshold value TH, but other difference values of the waveforms in the vicinity are not influenced, the difference value of the waveform may be erroneous determined.

As mentioned in the above, the prior art touch display device is a device combining the liquid crystal display panel and the transparent touch pad, to fulfill both touch and display functions. Such combination does not help integration of the hardware structures, and may further cause an increment to the whole thickness. In comparison, the present invention utilizes the source lines LS_1-LS_n originally formed in the liquid crystal display panel to sense electric variations caused by a finger or object. Accordingly, with the activation sequence of each gate lines in the liquid crystal display panel, the touch display device determines whether a touch event occurs, and/or where and when a touch event occurs via the touch detection device.

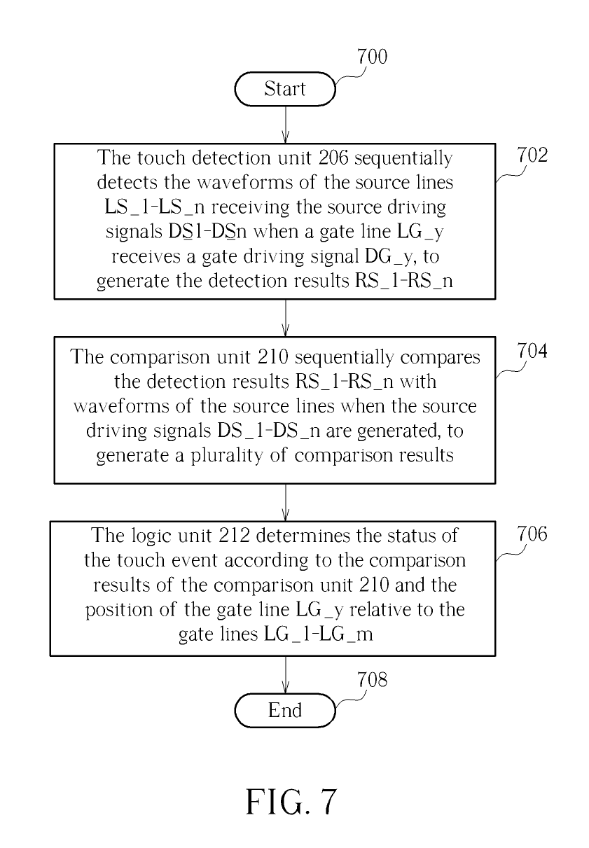

Furthermore, the above operations of the touch detection device 204 can be concluded into a touch detection process 70, as shown in FIG. 7. The touch detection process 70 includes the following steps:

Step 700: Start.

Step 702: The touch detection unit 206 sequentially detects the waveforms of the source lines LS_1-LS_n receiving the source driving signals DS_1-DS_n when a gate line LG_y receives a gate driving signal DG_y, to generate the detection results RS_1-RS_n.

Step 704: The comparison unit 210 sequentially compares the detection results RS_1-RS_n with waveforms of the source lines when the source driving signals DS_1-DS_n are generated, to generate a plurality of comparison results.

Step 706: The logic unit 212 determines the status of the touch event according to the comparison results of the comparison unit 210 and the position of the gate line LG_y relative to the gate lines LG_1-LG_m.

Step 708: End.

The touch detection process 70 is utilized for interpreting the operations of the touch detection device 204, and can be referred to the above narration for detail.

To sum up, by detecting the waveform of the source driving signals, the present invention determines whether a touch event occurs, and/or where and when a touch event occurs with activation sequence of each gate lines. Therefore, the present invention does not need an extra transparent touch pad, and hence the objectives of simplifying panel circuits, enhancing aperture ratio, enhancing display quality, and reducing production cost can be truly fulfilled.

Those skilled in the art will readily observe that numerous modifications and alterations of the device and method may be made while retaining the teachings of the invention.

What is claimed is:

1. A touch detection method, for detecting touch events in a flat panel display, the flat panel display comprising a plurality of source lines and a plurality of gate lines perpendicular to the plurality of source lines, the touch detection method comprising:
sequentially detecting waveforms of the plurality of source lines when receiving a plurality of source driving signals, and when a gate line of the plurality of gate lines receives a gate driving signal, to generate a plurality of detection results; and
determining a status of a touch event according to the plurality of detection results and position of the gate line relative to the plurality of gate lines.

2. The touch detection method of claim 1, wherein the step of determining the status of the touch event according to the plurality of detection results and position of the gate line relative to the plurality of gate lines comprises:
sequentially comparing the plurality of detection results with waveforms of the plurality of source lines when the plurality of source driving signals are generated, to generate a plurality of comparison results; and
determining the status of the touch event according to the plurality of comparison results.

3. The touch detection method of claim 2, wherein the step of determining the status of the touch event according to the plurality of comparison results is determining that the touch event occurs on an intersection of a source line corresponding to a comparison result and the gate line when a comparison result among the plurality of comparison results is greater than a predetermined value.

4. The touch detection method of claim 2, wherein the step of determining the status of the touch event according to the plurality of comparison results is determining that the touch event does not occur when the plurality of comparison results are smaller than a predetermined value.

5. The touch detection method of claim 2, wherein the step of determining the status of the touch event according to the plurality of comparison results is determining that an erroneous decision occurs when a predetermined amount of comparison results among the plurality of comparison results are larger than a predetermined value.

6. A touch detection device, for detecting touch events in a flat panel display, the flat panel display comprising a plurality of source lines and a plurality of gate lines perpendicular to the plurality of source lines, the touch detection device comprising:
a touch detection unit, for sequentially detecting waveforms of the plurality of source lines when receiving a plurality of source driving signals, and for when a gate line of the plurality of gate lines receives a gate driving signal, to generate a plurality of detection results; and
a determination module, for determining a status of a touch event according to the plurality of detection results and position of the gate line relative to the plurality of gate lines.

7. The touch detection device of claim 6, wherein the determination module comprises:
a comparison unit, for sequentially comparing the plurality of detection results with waveforms of the plurality of source lines when the plurality of source driving signals are generated, to generate a plurality of comparison results; and
a logic unit, for determining the status of the touch event according to the plurality of comparison results.

8. The touch detection device of claim 7, wherein the logic unit determines that the touch event occurs on an intersection of a source line corresponding to a comparison result and the gate line, when a comparison result among the plurality of comparison results is greater than a predetermined value.

9. The touch detection device of claim 7, wherein the logic unit determines that the touch event does not occur when the plurality of comparison results are smaller than a predetermined value.

10. The touch detection device of claim 7, wherein the logic unit determines that an erroneous decision occurs when a predetermined amount of comparison results among the plurality of comparison results are larger than a predetermined value.

11. A flat display device having display and touch functions, comprising:
a display panel, comprising a plurality of pixel units, a plurality of source lines, and a plurality of gate lines perpendicular to the plurality of source lines, each pixel unit formed at an intersection of a source line and a gate line;
an image driving module, for outputting a plurality of control signals and a plurality of image data to the plurality of gate lines according to an image data, to drive the plurality of pixel units to display images; and
a touch detection device, comprising:
a touch detection unit, for sequentially detecting waveforms of the plurality of source lines when receiving a plurality of source driving signals, and when a gate line of the plurality of gate lines receives a gate driving signal, to generate a plurality of detection results; and
a determination module, for determining a status of a touch event according to the plurality of detection results and position of the gate line relative to the plurality of gate lines.

12. The flat display device of claim 11, wherein the determination module comprises:
a comparison unit, for sequentially comparing the plurality of detection results with waveforms of the plurality of source lines when the plurality of source driving signals are generated, to generate a plurality of comparison results; and
a logic unit, for determining the status of the touch event according to the plurality of comparison results.

13. The flat display device of claim 12, wherein the logic unit determines that the touch event occurs on an intersection of a source line corresponding to a comparison result and the gate line, when a comparison result among the plurality of comparison results is greater than a predetermined value.

14. The flat display device of claim 12, wherein the logic unit determines that the touch event does not occur when the plurality of comparison results are smaller than a predetermined value.

15. The flat display device of claim 12, wherein the logic unit determines that an erroneous decision occurs when a predetermined amount of comparison results among the plurality of comparison results are larger than a predetermined value.
